(19) United States
(12) Patent Application Publication
(10) Pub. No.: US 2003/0193567 A1
(43) Pub. Date: Oct. 16, 2003

(54) Digital camera media scanning methods, digital image processing methods, digital camera media scanning systems, and digital imaging systems

(76) Inventor: Paul M. Hubel, Mt. View, CA (US)

Correspondence Address: HEWLETT-PACKARD COMPANY, Intellectual Property Administration, P.O. Box 272400, Fort Collins, CO, 80527-2400, US

(21) Appl. No.: 10/121,852

(22) Filed: Apr. 12, 2002

(51) Int. Cl. H04N 5/225

(52) U.S. Cl. 348/207.1

(57) ABSTRACT

Digital camera media scanning methods, digital image processing methods, digital camera media scanning systems, and digital imaging systems are described. According to one aspect, a digital camera media scanning method includes providing media to be scanned, providing a digital camera, moving at least one of the media and the digital camera with respect to the other of the media and the digital camera, generating a plurality of raw images of the media during the moving, generating a base image using digital data of one of the raw images and comprising a plurality of planes of digital data individually corresponding to one of a plurality of colors, determining an amount of movement between the one raw image and another of the raw images, populating the planes using digital data of the another raw image to implement super resolution, the populating comprising weighting the digital data of the another raw image using the amount of movement and combining the digital data of the planes of the base image after the populating to provide a composite image.

### FIELD OF THE INVENTION

The invention relates to digital camera media scanning methods, digital image processing methods, digital camera media scanning systems, and digital imaging systems.

### BACKGROUND OF THE INVENTION

Digital imaging systems have experienced vast improvements in recent years. For example, improvements in memory capacity and microprocessor speeds have resulted in significant improvements for digital imaging systems including increased processing speeds and increased available storage. Such improvements have led to increased popularity and acceptance of digital cameras by commercial entities as well as individuals.

Digital imaging systems including digital cameras have enjoyed significant improvements in resolution and memory capacity to provide systems of increased capabilities. The ability to display images in real time without having to wait for the development of exposures as required in analog systems is a significant improvement over conventional analog devices. Additional advantages of digital cameras enable an individual to download digital files of images from the digital camera to an associated host computer and/or printer. This downloading enables images to be communicated to remote locations using the Internet or other network system. Digital information of images may also be conveniently stored using flash memory, floppy disk or other storage device configurations.

The exemplary advancements in the field of digital cameras described above have led to the introduction of numerous models offering improved capabilities and features. Relatively inexpensive digital cameras are commonplace and are manufactured by numerous companies. The popularity of digital imaging systems and digital cameras is expected to increase. Accordingly, there will be an increased desire for systems and devices which provide further imaging advantages and product features.

### SUMMARY OF THE INVENTION

According to one aspect of the invention, a digital camera media scanning method comprises providing media to be scanned, providing a digital camera, moving at least one of the media and the digital camera with respect to the other of the media and the digital camera, generating a plurality of raw images of the media during the moving, generating a base image using digital data of one of the raw images and comprising a plurality of planes of digital data individually corresponding to one of a plurality of colors, determining an amount of movement between the one raw image and another of the raw images, populating the planes using digital data of the another raw image to implement super resolution, the populating comprising weighting the digital data of the another raw image using the amount of movement and combining the digital data of the planes of the base image after the populating to provide a composite image.

According to another aspect of the invention, a digital image processing method comprises accessing a plurality of raw images including digital data for a plurality of pixels, the digital data for an individual one of the pixels comprising digital data of no more than a single one of a plurality of different colors, generating a plurality of planes using one of the raw images, wherein a first of the planes includes digital data of no more than a first of the colors, and a second of the planes includes digital data of no more than a second of the colors, populating the planes using the digital data of another of the raw images and forming a composite image including combining the digital data of the planes.

According to an additional aspect of the invention, a digital camera media scanning system comprises a housing adapted to position a digital camera with respect to media to be scanned such that at least a portion of the media is within a focal plane of a lens of the digital camera, a memory configured to store a plurality of digital data rasters provided by the digital camera and corresponding to a plurality of respective raw images derived from different views and individually comprising a single plane mosaic image, of the media, and the digital data rasters individually comprise digital data of at least a common portion of the media located at different locations within the raw images corresponding to the different views of the media and processing circuitry configured to process the digital data rasters to provide a composite image of the media, the composite image including a resolution greater than individual resolutions of the raw images comprising single plane mosaic images.

According to yet another aspect of the invention, a digital imaging system comprises digital imaging components configured to generate a plurality of raw images of media using an area sensor including a plurality of pixel elements individually configured to provide information of no more than one color, processing circuitry configured to generate a plurality of planes from one of the raw image, the planes individually including a reduced resolution compared with a resolution of the one raw image and wherein the processing circuitry is further configured to combine digital data from another of the raw images with respective ones of the planes to increase the resolutions of the planes and to combine the planes including the increased resolutions to provide a composite image.

### DESCRIPTION OF THE DRAWINGS

FIG. 1 is an illustrative representation of an exemplary digital imaging system.

FIG. 2 is a functional block diagram of an exemplary digital imaging device of the digital imaging system.

FIG. 3 is an illustrative representation of an exemplary mosaic of color filters of the device of FIG. 2.

FIG. 4 is a functional block diagram of an exemplary host device of the digital imaging system.

FIG. 5 is a flow chart depicting an exemplary methodology for processing images.

FIG. 6 is an illustrative representation of another exemplary digital imaging system.

### DETAILED DESCRIPTION OF THE INVENTION

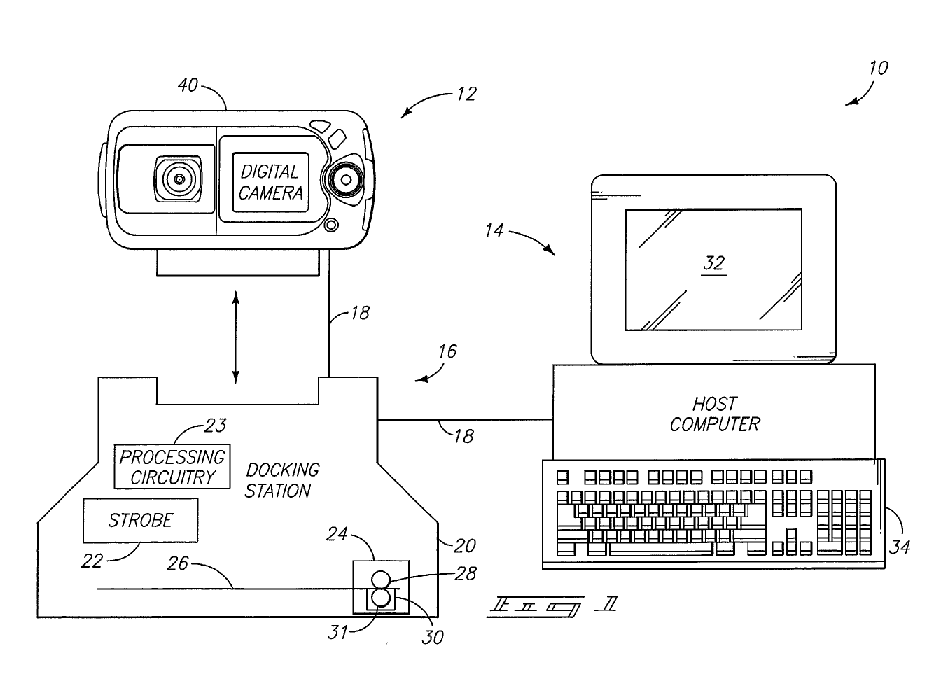

Referring to FIG. 1, an exemplary digital imaging system 10 according to one embodiment of the present invention is shown. The exemplary system 10 includes a digital imaging device 12, a host device 14, and a docking station 16.

Digital imaging device 12 is configured to generate rasterized digital data representations of objects viewed using optics of device 12. Device 12 is implemented as a digital camera 40 in the described exemplary embodiment although other configurations of device 12 are possible. Digital camera 40 may be implemented as a digital still camera, digital video camera or other appropriate digital camera device. Possible digital camera configurations include a model 812 or a model 912, both available from Hewlett Packard Company. Device 12 is configured to mate with docking station 16 in the illustrated embodiment.

The exemplary configuration of docking station 16 includes a housing 20 configured to receive device 12. The illustrated exemplary docking station 16 additionally includes a strobe 22, processing circuitry 23, and a media control system 24.

In the described exemplary embodiment, system 10 is configured to implement scanning operations of media 26 within housing 20. Media 26 comprises subject material to be scanned or otherwise reproduced into a digital data format using system 10. Exemplary media 26 comprises paper documents (e.g., A4 paper), photographic prints (e.g., 5″×7″ prints), slides, transparencies, negatives, business cards, and other two-dimensional visual representations of static scenes capable of being scanned or imaged using device 12. According to some aspects of the present invention and as described in further detail below, system 10 is configured to provide images of media 26 having increased resolution compared with images generated by device 12 alone during conventional operations. System 10 is configured to enable device 12 to observe and record different views of media 26 in successive exposures to implement enhanced imaging operations described below.

In the depicted embodiment, housing 20 is arranged to position device 12 with respect to media 26 such that at least a portion of media 26 is within a focal plane of optical components, including for example, one or more lens (e.g., normal and/or close-up lens) of device 12. According to one exemplary mode of operation, an entirety of media 26 is provided within a focal plane of device 12 during imaging operations although imaging operations herein may also be implemented to image only a portion of media 26 in other operational modes.

System 10 is arranged to control a position of media 26 within housing 20 and relative to device 12 as well as implement movement of media 26 within housing 20 in one operational mode. In one embodiment, media 26 is provided in a substantially flat position which is perpendicular to an optical axis of optics of device 12. A motor 28 of system 24 may be utilized to implement movement of media 26 to enable imaging operations according to aspects of the present invention. In other possible arrangements, device 12 (or area sensor 50 thereof described below) is moved while media 26 is stationary, or device 12 and media 26 are both moved during imaging operations. Movement of device 12, sensor 50 and/or media 26 enables device 12 to obtain images of different views of media 26. The movement in some implementations is not excessive and may be in sub-pixel increments between adjacent exposures. Movement may include and be represented as translation, rotation, zoom and\or projective distortions, for example. An encoder 30 may be provided to monitor movement of media 26. In one configuration, encoder 30 monitors movement of a feed wheel 31.

Host device 14 is operatively coupled with device 12 and/or docking station 16 in the illustrated arrangement. Data connections 18 provide communications between device 12, device 14 and\or station 16. The exemplary data connection 18 between device 14 and station 16 may be hard wired or other appropriate medium (e.g., IR or RF) for communicating digital data. Data connection 18 between device 12 and station 16 may be implemented using direct electrical contacts when camera 12 is received within station 16 or other appropriate coupling (e.g., USB or FIR interface). Connections 18 are configured to communicate any appropriate signals between device 12, device 14 and station 16. For example, digital data, electrical power, control signals, etc. may be communicated between respective device 12, device 14 and station 16 using connections 18. Other connection configurations are possible to provide operational communications between respective devices 12, 14, 16. Device 12 may be coupled directly to host device 14 in one other such possible implementation.

In the depicted exemplary embodiment, host device 14 is implemented as a personal computer or workstation including processing circuitry (not shown in FIG. 1), a display 32, and a user interface 34. Media 26 being scanned may be displayed using display 32 and modified responsive to commands received via user interface 34 in one possible arrangement.

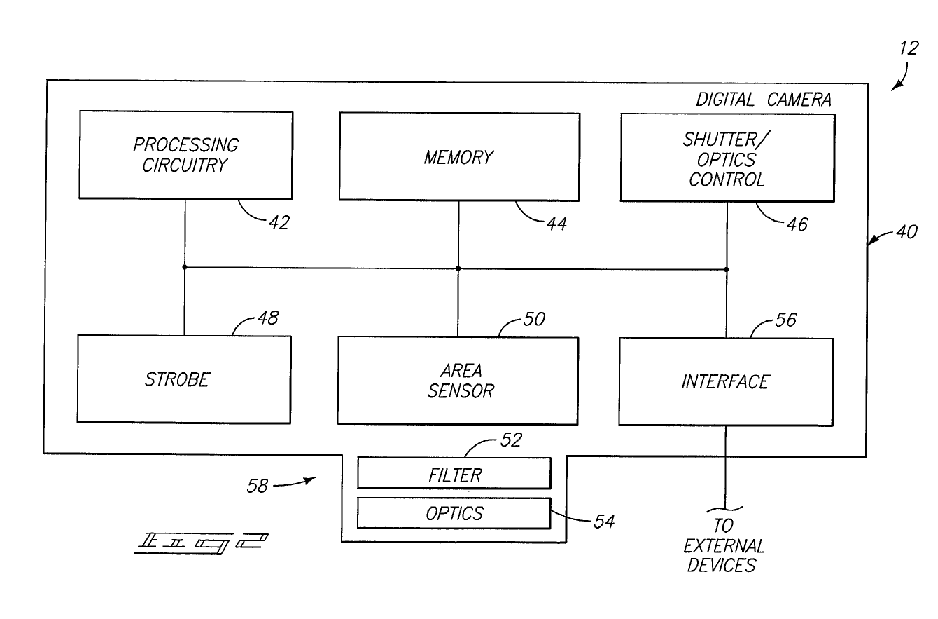

Referring to FIG. 2, digital imaging device 12 is illustrated in an exemplary configuration comprising a digital camera 40. Digital camera 40 in the illustrated configuration includes processing circuitry 42, a memory 44, shutter/optics control 46, a strobe 48, an area sensor 50, a filter 52, optics 54, and an interface 56.

Area sensor 50 and filter 52 comprise digital imaging components 58 configured to provide raw image data of a plurality of raw images (also referred to as single full plane mosaic images of media). The raw image data comprises digital data corresponding to a plurality of pixels of the raw images formed by area sensor 50 and filter 52. For example, the raw images comprise bytes corresponding to the colors of red, green and blue at respective pixels in an exemplary RGB application. Other embodiments may utilize cyan, magenta, yellow and black (CMYK) information or other color information.

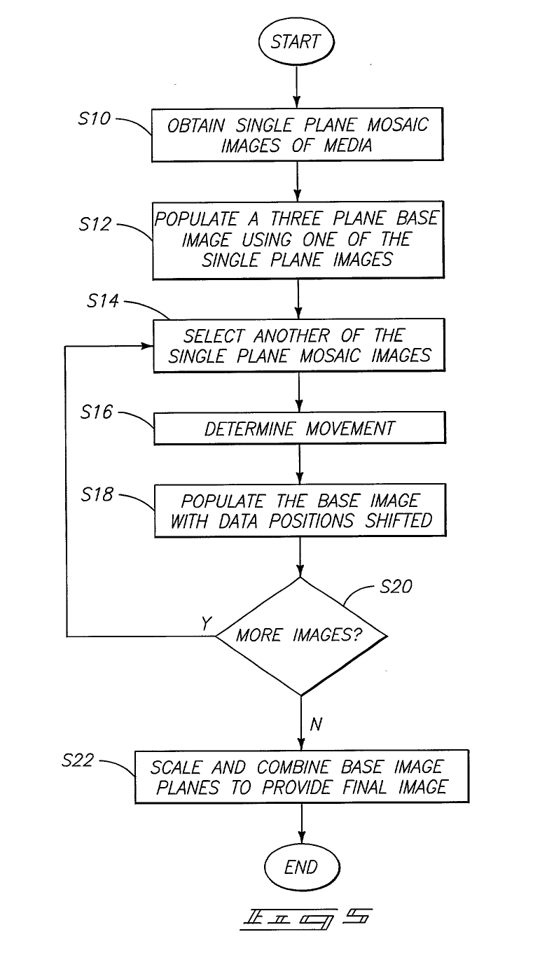

In one embodiment, area sensor 50 and filter 52 provide raw images wherein the digital data for individual pixels includes information for no more than one color. The raw images are used to form a composite image as described below wherein digital data or information is enhanced for individual pixels (i.e., the resolution is enhanced). For example, the composite image comprises digital data for at least some of the pixels having information for more than one color and perhaps three colors, red, green and blue. An exemplary methodology for generating a composite image is discussed in detail below with respect to FIG. 5.

According to one exemplary arrangement, processing circuitry 42 is implemented as a dedicated micro-controller configured to execute instructions to control imaging operations of media 26 (e.g., control strobe 48, optics 54, control circuitry 46 and/or other components of device 12), movement of media 26, device 12, and/or sensor 50, processing of images, communications with external devices, and any other desired operations.

Memory 44 is arranged to store digital information and instructions. Memory 44 may include a buffer configured to receive raw raster data of images from area sensor 50 and to store such data for processing internally or externally of device 12. In at least one embodiment, memory 44 is configured to store a plurality of raw digital data files provided by area sensor 50 and corresponding to a plurality of respected raw images derived from different views of media 26. In addition, memory 44 may include flash memory, random access memory and/or read only memory configured to store other digital information including software or firmware instructions utilized by processing circuitry 42, and any other digital data utilized within device 12.

Shutter/optics control 46 implements focusing operations of optics 54, controls a shutter and aperture of optics 54, performs zoom operations, and performs any other desired control operations of optics 54. In one embodiment, shutter/optics control 46 includes a plurality of motors which are controlled by processing circuitry 42.

Strobe 48 comprises a light source configured to provide light for usage in imaging of media 26. Processing circuitry 42 controls operation of strobe 48 in the described embodiment. Strobe 48 may be disabled, utilized alone or in conjunction with strobe 22 of station 16.

Area sensor 50 comprises a plurality of photosensitive elements, such as photodiodes, corresponding to pixels and configured to provide digital data for generating images of media 26. For example, area sensor 50 may comprise a raster of photosensitive elements (also referred to as pixel elements) arranged in 1600 columns by 1280 rows in one possible configuration. Other raster configurations are possible. Photosensitive elements may individually comprise charge coupled devices (CCDs) or CMOS devices in exemplary configurations.

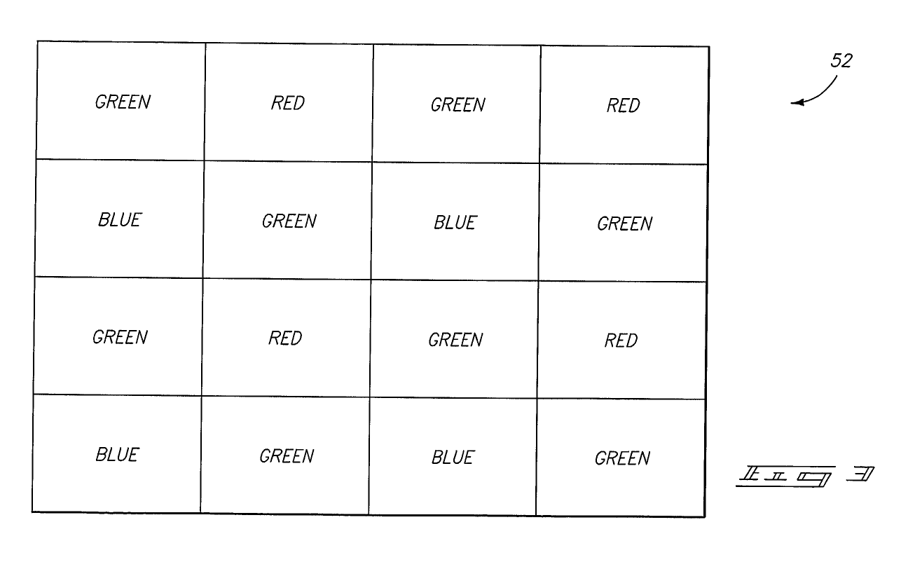

Filter 52 is implemented between area sensor 50 and optics 54. Filter 32 is arranged to implement filtering operations of received light from optics 54 prior to application of the light to sensor 50. An exemplary configuration of filter 52 is depicted in FIG. 3 providing raw data according to a Bayer Mosaic pattern. In the depicted exemplary illustration of filter 52, alternating rows of green—red filters and blue—green filters are provided. Individual ones of the red, green and blue filters correspond to a single photosensitive element of sensor 50. More specifically, the depicted green, red and blue filter squares of FIG. 3 are sized to correspond to individual elements or pixels of area sensor 50. The filter 52 depicted in FIG. 3 configures the elements or pixels of area sensor 50 to individually provide information regarding no more than one color. For example, using the filter 52 of FIG. 3, individual elements of area sensor 50 provide either green, red or blue information. Other configurations of sensor 50 and filter 52 are possible.

As described further below, the data from area sensor 50 is utilized to formulate three planes providing a red image, green image and a blue image. The illustrated filter arrangement provides a red image of ¼ the resolution of an original image provided by sensor 50, a green image of ½ the resolution, and a blue image of ¼ the resolution. As mentioned above, other configurations of filter 52 are possible.

The depicted arrangement of filter 52 comprises a 4×4 raster for explanation purposes. In typical implementations, filter 52 is much larger wherein the depicted pattern is repeated for the entire area sensor 50 (e.g., the total number of individual red, green, and blue filters corresponds to the number of photosensitive elements of sensor 50).

Interface 56 is configured to provide communications of control signals, power signals and\or any other signals of device 12 with host device 14, docking station 16 or other external device. Interface 56 comprises electrical contacts or pins configured to mate with station 16 in one possible implementation.

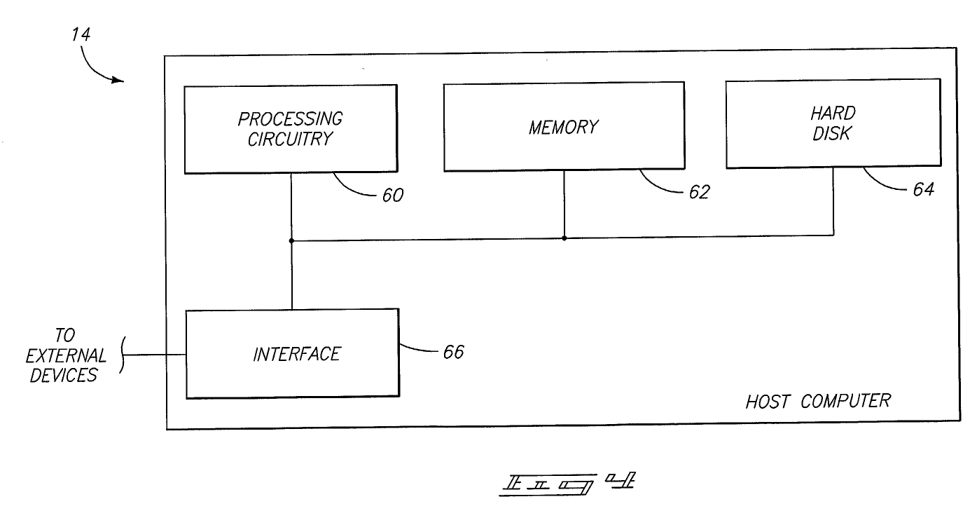

Referring now to FIG. 4, an exemplary configuration of host device 14 is shown. As mentioned above, host device 14 comprises a workstation or a personal computer in the depicted exemplary embodiment. Other arrangements of device 14 are possible. Exemplary components of device 14 include processing circuitry 60, a memory 62, a hard disk 64, and an interface 66.

Processing circuitry 60 is configured as a microprocessor available, for example, from Intel Corporation or Advanced Micro Devices, Inc. Circuitry 60 is arranged to execute instructions to implement processing of digital data from device 12 and\or control operations of system 12 depending upon the desired implementation.

Memory 62 may include random access memory, read only memory, flash memory and other arrangements capable of storing digital data. Such data can include, for example, instructions executable by processing circuitry 60 and raster data generated by device 12.

Hard disk 64 may be arranged to receive and store digital data rasters from digital device 12 as well as store instructions executable by processing circuits including circuitry 60 and other desired digital data.

Interface 66 comprises a high-speed data connection to implement communications of device 14 with device 12 and/or docking station 16. Interface 66 comprises an input/output device configured to implement bi-directional communications in the depicted configuration.

Referring again to FIG. 1, system 10 is configured to provide scanning operations of media 26 in at least one operational mode. System 10 is configured to provide images of media 26 having increased spatial resolution and\or color resolution compared with resultant images generated using device 12 operated in a conventional mode. According to one embodiment, system 10 implements super resolution image processing techniques to provide increase spatial and\or color resolution. Exemplary super resolution techniques are described in “Restoration of a Single Superresolution Image from Several Blurred, Noisy, and Undersampled Measured Images”, listing Michael Elad and Arie Feuer as authors, IEEE, 1997; “Super-Resolution from Multiple Images Having Arbitrary Mutual Motion”, listing Assaf Zomet and Shmuel Peleg as authors, Chapter Two of Super-Resolution Imaging, Kluwer Academic (S. Chaudhuri ed. September 2001); and “A Computationally Efficient Supperresolution Image Reconstruction Algorithm”, listing Nhat Nyguen, Peyman Milanfar, and Gene Golub as authors, IEEE Transactions on Image Processing, Vol. 10, No. 4, April 2001; and the teachings of all the articles are incorporated herein by reference.

Super resolution processing techniques implemented in accordance with exemplary aspects of the present invention utilize digital data from a plurality of raw images of device 12 and derived from different views of media 26 to enhance the resolution of a resultant scanned image. As mentioned above, device 12 is configured to generate a plurality of raw images of media 26 during movement between device 12, optics 54, and/or sensor 50 and/or media 26. Images may be taken in succession to provide different views having incremental displacements of movement of device 12, optics 54, and\or sensor 50 and/or media 26 between exposures.

Accordingly, at least one of device 12, sensor 50 and media 26 is moved relative to the other between exposures to provide images from different views. The illustrated exemplary station 16 is configured to implement the movement in one embodiment in accordance with super resolution processing techniques. As shown in FIG. 1, control system 24 is arranged to implement movement of media 26 with respect to device 12 in the depicted exemplary embodiment. Control system 24 includes motor 28 configured to provide movement of media 26 responsive to appropriate control signals. In other alternative configurations, station 16 may be arranged to provide movement of device 12 relative to media 26 or provide movement of both device 12 and media 26. Further, sensor 50 may be moved while device 12 is stationary in other configurations.

Information regarding an amount of movement between images is utilized in exemplary super resolution processing of the images. Encoder 30 (FIG. 1) may be utilized to provide movement information of media 26. Movement information may also be derived from the images. For example, device 12, device 14 or station 16 may be utilized to calculate movement information of device 12, sensor 50 and\or media 26 during imaging of media 26. In one arrangement, one or more of processing circuits 23, 42, 60 are configured to calculate the movement information. Exemplary techniques for determining movement information from images having common features are described in detail in a U.S. Patent Application entitled “Imaging Apparatuses, Mosaic Image Compositing Methods, Video Stitching Methods and Edgemap Generation Methods,” naming Irwin Sobel and Paul Hubel as inventors, assigned to the assignee of the present invention, filed the same day as the present application, and incorporated herein by reference. Using such exemplary techniques, the amount of movement between images may be calculated by identifying one or more feature within the images using digital data of the raw images and determining the movement of the one or more feature intermediate the images. Such calculations may be utilized alone or to supplement information from encoder 30.

Accordingly, digital data files corresponding to the raw images derived from different views of media 26 may individually comprise at least a common portion (e.g., feature) of media 26 located at different locations within the raw images and corresponding to the different views of media 26 as observed via device 12. The position of the common portion in one image is compared with a position of the common portion in another image to determine movement information in the exemplary configuration. Other arrangements or methodologies are possible for determining movement information.

Referring to FIG. 5, an exemplary methodology performed by one of processing circuits 23, 42, 60 or distributed among such circuits 23, 42, 60 is shown to illustrate exemplary imaging operations. It is to be understood that processing operations described herein may be performed by processing circuitry 23, 42, 60 of one of devices 12, 14, or station 16, or alternatively, processing operations are distributed among a plurality of the processing circuits 23, 42, 60. The particular configuration implemented may be determined by the clock speed of such processing circuits 23, 42, 60, other functions being controlled by such circuitry, reserved capacities of the given device, or other considerations. The depicted exemplary methodology provides scanning operations to improve resolution compared with single raw images in accordance with exemplary aspects of the invention. Other methodologies are possible.

At a step S10, the processing circuitry obtains single full plane mosaic images of the media comprising raw image digital data. At least some of the single full plane mosaic images are generated from different views of the media.

At a step S12, the processing circuitry generates a base image comprising a plurality of planes using raw digital data of one of the single full plane mosaic images provided by area sensor 50. In the described exemplary configuration, the single full plane mosaic images have a mosaic pattern provided by filter 52 shown in FIG. 3, wherein individual elements of area sensor 50 provide information of one respective color of red, green, or blue. The processing circuitry is configured to populate a three plane base image buffer with planes R^{b}, G^{b}, B^{b} using data from the single full plane mosaic image. The base image comprises three planes of digital data individually corresponding to one of the colors red, blue, and green. The three planes generated and buffered in appropriate memory include information for the respective colors as generated by the respective color elements of sensor 50 during imaging of the single full plane mosaic image and the planes are missing information from elements dedicated to the other colors. Accordingly, the processing circuitry at step S12 populates the three plane base image using digital data from one of the single full plane mosaic images.

For example, and also referring to the filter in FIG. 3, the first of the base planes includes digital data of no more than a first of the colors, a second of the planes includes digital data of no more than a second of the colors, and a third of the planes includes digital data of no more than a third of colors. In the illustrated example, the first plane includes information corresponding to red elements of sensor 50, a second plane includes information corresponding to green elements of sensor 50, and the last plane includes information corresponding to blue elements of sensor 50.

The population in step S12 is partial population inasmuch as the single full plane mosaic image provides information for one color at individual element locations or pixels. Accordingly, some pixels of the base planes (i.e., planes of the base image) are individually missing information wherein the respective sensors or elements are dedicated to another of the base planes for a different color. It follows that the planes of the base image individually have a reduced resolution compared with resolutions of the single full plane mosaic images. The generated planes of the base image individually contain digital data of no more than one respective color in accordance with one exemplary methodology.

The processing circuitry proceeds to a step S14 to select another of the single full plane mosaic images including digital data of another image and representing a different view than the view of the image utilized to formulate the three plane base image of step S12. The processing circuitry may select another of the single full plane mosaic images occurring immediately after the single full plane mosaic image utilized to generate the three planes of the base image. Alternatively, other selection criteria may be utilized to select the next single full plane mosaic image of raw data.

At a step S16, the processing circuitry determines an amount of movement between the one single full plane mosaic image utilized to generate the three plane base image and the single full plane mosaic image selected in step S14. As described above, exemplary methods of determining movement information include using information from encoder 30 and\or performing calculations using features of the images.

At a step S18, the processing circuitry is configured to populate the three base plane images R^{b}, G^{b}, B^{b} using digital data from the image selected in step S14. According to one exemplary methodology, the processing circuitry is configured to implement super resolution techniques to populate the three planes of the base image. According to one exemplary super resolution implementation, the processing circuitry adds new data from the image selected in step S14 with respective data positions thereof shifted by Δx, Δy, ΔΦ (or other parameters) determined by the movement information and using weights (σ). Accordingly, the populating of step S18 comprises weighting the digital data of the image selected in step S14 using movement information determined in step S16. The processing circuitry is configured to combine digital data from the image selected in step S14 with digital data of the three planes of the base image to increase the spatial resolution of the individual color planes.

At a step S20, it is determined whether additional single full plane mosaic images of raw digital data should be processed to further populate the three planes of the base image. If additional images remain, the processing circuitry returns to step S14 and step S16 to implement the super resolution technique according to the exemplary embodiment.

Alternatively, the processing circuitry proceeds to a step S22 to scale and combine the planes of the base image to provide a composite image. The resultant composite image from step S22 includes a resolution greater than individual resolutions of the single full plane mosaic images comprising raw data. It also follows that the composite image has a resolution greater than individual resolutions of the planes of the base image. In addition, the composite image avoids artifacts resulting from standard reconstruction techniques of conventional digital cameras. Exemplary composite images comprise digital data for at least some of the individual pixels having information of more than one color and perhaps three colors, red, green and blue.

Following the population of the respective planes of the base image using information from the available single full plane mosaic images, individual planes of increased resolution relative to the first image of step S12 are provided. However, using the filter 52 shown in FIG. 3, the three planes of the base image have differing resolution following the population using the other single full plane mosaic images. In the described exemplary configuration, the planes of the base image including respective red, green, blue information have respective resolutions of ¼, ½, ¼, of the original single full plane mosaic image of step S12. The planes of increased resolution are scaled to provide the planes with a common spatial resolution before combining. Following the appropriate scaling, the scaled planes are combined to form the fully populated or composite image of step S22. In some super resolution techniques, the resultant planes have a common spatial resolution and the resultant planes may be combined without scaling to form the composite image.

Interpolation of digital data of the composite image formed by combining the base planes may be implemented to provide further information for missing color values. An exemplary interpolation method includes bilinear interpolation. Accordingly, digital data from a plurality of single full plane mosaic images of media is combined prior to any interpolation of the digital data according to one aspect of the invention. The three planes of the base image are formed, the resolution of the three planes is enhanced, and thereafter the three planes are combined to form the composite image of enhanced resolution. The enhancement of the resolution of the three planes of the base image occurs prior to demosaicing (e.g., using interpolation) of the base planes or the composite image according to this aspect.

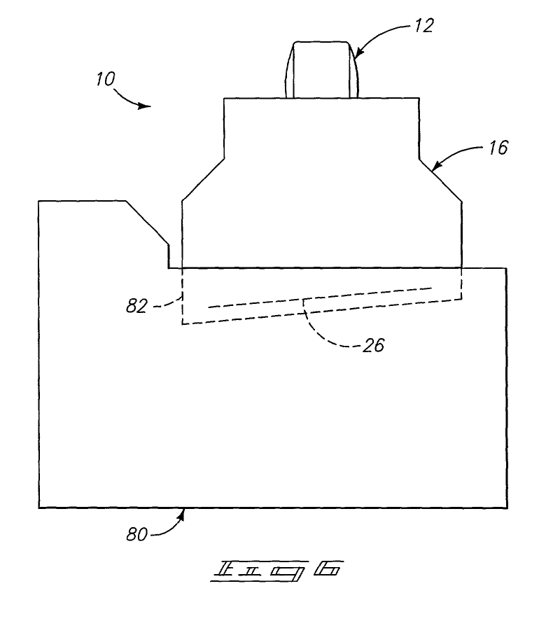

Referring to FIG. 6, another exemplary configuration of a scanning system according to aspects of the invention is described. The depicted arrangement illustrates station 16 of system 10 positioned adjacent an output tray 82 of a printer 80. Printer 80 may be implemented as a laser printer, inkjet printer, etc. and provides movement of media 26 along a paper path terminating at output tray 82. In the depicted arrangement of FIG. 6, it may be possible to omit motor 28 of the station 16 inasmuch as printer 80 operates to move media 26 during printing operations. The embodiment of FIG. 6 may be implemented in a photo kiosk arrangement.

Station 16 is arranged to enable device 12 to expose a plurality of single full plane mosaic images of media 26 moving within the output tray 82. Station 16 may alternatively be located at any other convenient location along a paper path of printer 80. Although not shown in FIG. 6, host device 14 may also be coupled with device 12, station 16 and/or printer 80. Other configurations and applications of system 10 are possible.

Exemplary aspects of the present invention enhance the resolution of a plurality of respective color planes of a base image (e.g., low resolution images) using digital data from a plurality of single full plane mosaic images and combine the color planes prior to demosaicing to provide a composite image of increased resolution. Demosaicing, such as bilinear interpolation, may be utilized after the composite image is formed. Alternatively, demosaicing may be implemented upon the individual color planes prior to combination.

Typically, the digital data of raw images comprise an entirety of the media being imaged. Alternatively, video stitching may be utilized in combination with super resolution using raw video data if some of the images of the media contain information not present in others of the images.

Images of the media being scanned may be processed real time during imaging using device 12, or alternatively stored and processed at a later point in time. Utilizing aspects of the invention, a composite image of 4-5 million pixels may be obtained using a digital camera configuration capable of providing a resolution of 2 million pixels. It is believed that with a video stitching mosaic technique (see the U.S. Patent Application incorporated by reference above) and super resolution, higher resolutions may be obtained (e.g., 50 million pixels for a 5″×7″ print scanning at 1600 ppi). The size of the imaging system components may be reduced by implementing video stitching with super resolution. Further, additional processing techniques may be utilized to improve the quality of the composite images including sharpening, edge directed smoothing, dynamic range compression, white-point detection, etc. In the case of document scanning, character recognition processing may be utilized. It is believed that image quality is comparable and potentially greater than scanners which utilize linear sensors. In addition, aspects of the invention enable a digital camera to be utilized as a stand-alone device or as a scanner or other high-resolution imaging device, and also provide a digital imaging system in a compact footprint (less than conventional scanners), at an inexpensive cost.

The protection sought is not to be limited to the disclosed embodiments, which are given by way of example only, but instead is to be limited only by the scope of the appended claims.

What is claimed is:

1. A digital camera media scanning method comprising:
providing media to be scanned;
providing a digital camera;
moving at least one of the media and the digital camera with respect to the other of the media and the digital camera;
generating a plurality of raw images of the media during the moving;
generating a base image using digital data of one of the raw images and comprising a plurality of planes of digital data individually corresponding to one of a plurality of colors;
determining an amount of movement between the one raw image and another of the raw images;
populating the planes using digital data of the another raw image to implement super resolution, the populating comprising weighting the digital data of the another raw image using the amount of movement; and
combining the digital data of the planes of the base image after the populating to provide a composite image.

2. The method of claim 1 further comprising interpolating at least some of the digital data of the planes after the combining to provide the composite image.

3. The method of claim 1 further comprising scaling at least some of the digital data of the planes after the populating and before the combining.

4. The method of claim 1 wherein the determining the amount of movement comprises calculating the amount of movement using the digital data of the one raw image and the another raw image.

5. The method of claim 1 wherein the combining comprises combining prior to any interpolation of the digital data of the one raw image and the another raw image.

6. The method of claim 1 wherein the generating the base image comprises generating the base image comprising three planes of digital data individually corresponding to one of the colors red, blue and green.

7. A digital image processing method comprising:
accessing a plurality of raw images including digital data for a plurality of pixels, the digital data for an individual one of the pixels comprising digital data of no more than a single one of a plurality of different colors;
generating a plurality of planes using one of the raw images, wherein a first of the planes includes digital data of no more than a first of the colors and a second of the planes includes digital data of no more than a second of the colors;
populating the planes using the digital data of another of the raw images; and
forming a composite image including combining the digital data of the planes.

8. The method of claim 7 wherein the generating comprises generating a third plane including digital data of no more than a third of the colors.

9. The method of claim 7 further comprising providing the raw images using a digital imaging device comprising an area sensor and a mosaic filter.

10. The method of claim 7 further comprising providing the raw images using a digital camera.

11. The method of claim 7 wherein the one raw image and the another raw image comprise different views of media.

12. The method of claim 11 further comprising determining movement information intermediate the one raw image and the another raw image, and the populating comprises populating using the movement information.

13. The method of claim 12 wherein the populating comprises weighting at least some of the digital data of the another raw image using the movement information.

14. The method of claim 7 wherein the populating comprises populating using super resolution.

15. The method of claim 7 further comprising scaling the digital data of at least some of the planes after the populating and before the forming.

16. The method of claim 7 wherein the generating, the populating and the combining comprise using processing circuitry of a host device coupled with a digital imaging device.

17. The method of claim 7 wherein the forming comprises interpolating digital data of the composite image after the combining.

18. A digital camera media scanning system comprising:
a housing adapted to position a digital camera with respect to media to be scanned such that at least a portion of the media is within a focal plane of a lens of the digital camera;
a memory configured to store a plurality of digital rasters provided by the digital camera and corresponding to a plurality of respective raw images derived from different views of the media and individually comprising a single full plane mosaic image, and the digital data rasters individually comprise digital data of at least a common portion of the media located at different locations within the raw images corresponding to the different views of the media; and
processing circuitry configured to process the digital data rasters to provide a composite image of the media, the composite image including a resolution greater than individual resolutions of the raw images comprising single full plane mosaic images.

19. The system of claim 18 wherein the processing circuitry is configured to utilize one of the raw images to generate a base image comprising a plurality of planes individually containing digital data of no more than one color, to partially populate the planes using respective digital data from the one raw image, to additionally populate the planes using respective digital data from another of the raw images, and to form the composite image using the planes after the additional population.

20. The system of claim 18 wherein the processing circuitry is configured to implement the additional population of the planes using movement information between the different views corresponding to the one raw image and the another raw image.

21. The system of claim 20 wherein the processing circuitry is configured to determine the movement information from the one raw image and the another raw image.

22. The system of claim 18 wherein the processing circuitry is configured to additionally populate the planes using super resolution.

23. The system of claim 18 wherein the processing circuitry is configured to scale the digital data of the planes after the additional population and prior to the formation of the composite image.

24. The system of claim 18 further comprising the digital camera comprising an area sensor and a mosaic of different color filters.

25. The system of claim 18 wherein the processing circuitry comprises a processor of the digital camera.

26. The system of claim 18 further comprising a host device coupled with the memory, and wherein the processing circuitry comprises a processor of the host device.

27. The system of claim 18 further comprising a printer configured to provide movement of the media intermediate at least some of the raw images.

28. A digital imaging system comprising:
digital imaging components configured to generate a plurality of raw images of media using an area sensor including a plurality of pixel elements individually configured to provide chrominance information of no more than one color;
processing circuitry configured to generate a plurality of planes from one of the raw image, the planes individually including a reduced resolution compared with a resolution of the one raw image; and
wherein the processing circuitry is further configured to combine digital data from another of the raw images with respective ones of the planes to increase the resolutions of the planes and to combine the planes including the increased resolutions to provide a composite image.

29. The system of claim 28 wherein the processing circuitry is configured to generate the planes individually containing digital data of no more than one color.

30. The system of claim 28 wherein the digital imaging components comprise components of a digital camera.

31. The system of claim 28 wherein the processing circuitry is configured to use super resolution to increase the resolutions of the planes.

32. The system of claim 28 wherein the processing circuitry is configured to scale spatial resolution of at least one of the planes before combining the planes.

33. The system of claim 28 wherein movement of at least one of the digital imaging components and the media occurs between the generation of the one raw image and the another raw image using the digital imaging circuitry, and the processing circuitry is configured to determine movement information regarding the movement and to combine the digital data from the another raw image with the planes using the movement information.

34. The system of claim 33 wherein the processing circuitry is configured to weight at least some of the digital data from the another raw image using the movement information.

35. The system of claim 28 wherein the processing circuitry is configured to combine the planes prior to any interpolation of digital data of the raw images.
